(19) United States
(12) Patent Application Publication
(10) Pub. No.: US 2006/0250972 A1
(43) Pub. Date: Nov. 9, 2006

(54) Method and test device for detecting an error rate

(76) Inventors: Pirmin Seebacher, Rosenheim (DE); Uwe Baeder, Ottobrunn (DE); Thomas Braun, Muenchen (DE)

Correspondence Address: Phouphanomketh Ditthavong;Ditthavong & Carlson, 10507 Braddock Road, Suite A, Fairfax, VA, 22032, US

(21) Appl. No.: 10/559,007

(22) PCT Filed: May 27, 2004
(86) PCT No.: PCT/EP04/05729

§ 371 Date: May 10, 2006

(30) Foreign Application Priority Data
May 30, 2003 (DE) 103 24 745.9

(51) Int. Cl. H04L 12/26

(52) U.S. Cl. 370/242

(57) ABSTRACT

A method and device for detecting an error rate of a receiver of data transmitted to a device that is to be checked is provided. A test device generates a data block having a first length and a test signal generated based on the data block is sent. The device to be checked receives and evaluates the test signal. Another data block having a different length is generated based on the evaluated test signal to obtain another data rate. The other data block is sent as a response signal in a different transmission direction, and is received and evaluated by the transmitter/receiver device of the test device. An evaluation unit compares the contents of both data blocks to detect the error rate, wherein the content of the shorter data block is compared with the content of a corresponding segment of the longer data block to determine the error rate.

### FIELD OF THE INVENTION

The invention relates to a method and a testing device for determining an error rate of a receiver device.

### BACKGROUND OF THE INVENTION

In order to determine the quality of a signal receiver device, a test signal is transmitted to a device under test containing the receiver device to be tested. The test signal is generated from a first data block according to a transmission protocol. The device under test receives the test signal and evaluates it; that is to say, the device under test reverses processes, which were implemented on the basis of the transmission protocol, in order to recover the original data contained in the test signal. In an ideal case, in which no errors have occurred either over the transmission path or in the evaluation, the evaluated test signal of the device under test matches perfectly the content of the originally transmitted first data block; that is to say, it is identical bit-wise.

From the evaluated test signal, the device under test then generates a second data block, which is conditioned to form a response signal in a similar manner to the first data block corresponding to the transmission protocol used. This response signal is transmitted back to the testing device by the device under test. The testing device can now compare the content of the first data block with the content of the evaluated response signal, which contains the data of the second data block and can therefore determine, for example, a bit error rate (BER) from the deviations between the content of the first data block and the content of the second data block. In this comparison, the first and second data blocks are compared with one another bit-wise. The first and the second data block are normally identical in length, because identical transmission rates are used for both transmission directions.

A disadvantage of this method is that the capability of modern transmission systems to realize different data rates in both transmission directions is not taken into consideration. As a result of this failure to utilize one transmission direction, the statistical value of the error-rate measurement is limited, because, in many cases, an increase in the data rate is also associated with an increase in the error rate of the corresponding device under test or of its receiver device.

### SUMMARY OF THE INVENTION

There exists a need to provide a method and a testing device for determining an error rate, which provides a statistically valuable measured result for the use of different data rates of a bidirectional channel.

In accordance with one aspect of the present invention, a test signal is transmitted in a first transmission direction from a testing device to a device under test. The test signal is generated from a first data block or a first group of data blocks, of which the content is also determined by the testing device. The device under test receives the test signal and evaluates it, so that in an ideal case, that is to say, with an error rate of zero percent, it contains the complete, bit-wise identical content of the first data block or the first group of data blocks. This evaluated test signal is used by the device under test to generate a second data block or a second group of data blocks, from which the device under test then generates a response signal.

The second data block, which is generated by the device under test, therefore differs in length from the first data block generated by the testing device. The length of the data blocks for the first or second transmission direction is therefore dependent upon the data rate of the respective transmission direction. In the case of an error-free transmission, the content of the shorter data block is identical to a given section of the longer data block. The first data block may be longer than the second data block, as is typically the case with mobile telephone systems of the third generation (e.g. UMTS) in the downlink; or the second data block may be longer than the first. The latter case can occur, e.g. when a base station of a mobile telephone network is being tested.

As an alternative, the different data rate can also occur through a formation of groups including several data blocks, a different number of data blocks of a first or second group respectively being used in the two transmission directions. In an error-free transmission, the data blocks from the group with the smaller number of data blocks then agree bit-wise with a given selection of data blocks in the group with the larger number of data blocks. This agreement applies at least to sections of data blocks, if a different length of the data blocks for first and the second group is selected in addition to the different number of data blocks in the first or second group respectively.

The testing device then receives the response signal and evaluates it. The section in the first data block and the second data block, which agree in an error-free transmission, or respectively, the data blocks of the first and second group, which agree at least in sections in an error-free transmission, are checked by the testing device with reference to their agreement. For this purpose, if different lengths of data block are used, the evaluated response signal or respectively a section thereof is compared bit-wise with the content of a given section of the first data block or respectively with the entire first data block. A bit-error rate or a block-error rate, for example, can then be determined by the testing device from the resulting deviations. If a different number of the data blocks are used in the first and the second group, the evaluation takes place in a corresponding manner through a bit-wise comparison of the corresponding data blocks of the first and second group. If the length is additionally different, the relevant sections of the corresponding data blocks are compared with one another bit-wise.

An evaluation cycle of this kind is repeated many times to obtain a statistically-secured error rate from a large number of transmitted test signals and received response signals.

To determine the performance of a receiver unit, it is particularly advantageous if the maximum possible data rate is used in the first transmission direction. Since the quality of the receiver device frequently varies with the data rate used, using the maximum realizable data rate means that the error rate of the receiver device can be determined under maximum stress, because the maximum amount of data may be processed per unit of time. This provides a comparison criterion relating to the most critical conditions in use.

A further advantage is provided in one embodiment if a baseband signal is transmitted between the testing device and the device under test instead of a high-frequency signal. Errors occurring in the further processing of the baseband signal, when generating or, for example, mixing a high-frequency transmission signal, are therefore excluded, so that those components, which relate to the processing of the baseband signal, can be tested specifically. For the transmission of the baseband signal, the baseband signal is picked up at a corresponding position of the signal processing both in the testing device and also in the device under test.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

Preferred exemplary embodiments of the method according to the invention are illustrated in the drawings and explained in greater detail below. The drawings are as follows:

FIG. 1 shows a simplified presentation of a first arrangement for the implementation of a method according to the present invention,

FIG. 2 shows a simplified presentation of a second arrangement for the implementation of a method according to the present invention,

FIG. 3 shows a schematic presentation of a first example of signal processing for error correction,

FIG. 4 shows a schematic presentation of a second example of signal processing for error correction,

FIG. 5 shows a schematic presentation of the processing of data blocks of different length in both transmission directions,

FIG. 6 shows an exemplary, tabular listing of connection parameters used in a first and a second transmission direction,

FIG. 7 shows a schematic presentation of a first example of the processing of groups of data blocks with a different number of data blocks in the two transmission directions, and

FIG. 8 shows a schematic presentation of a second example for the processing of groups of data blocks with a different number of data blocks in the two transmission directions.

### DETAILED DESCRIPTION OF THE PREFERRED EMBODIMENT

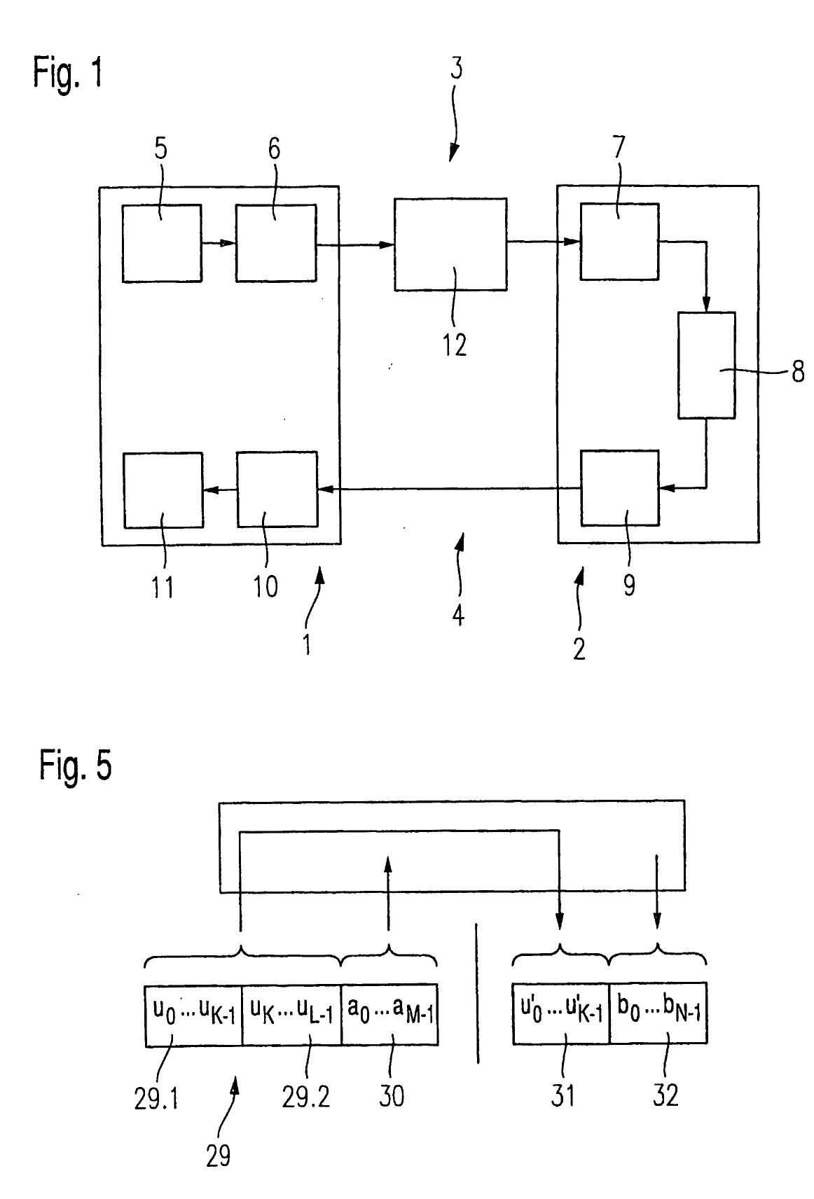

FIG. 1 shows schematically the procedure for determining an error rate of a device under test. The description below relates to an application in a mobile telephone system, especially of the third generation, wherein, however, express reference is made to the fact that the method according to the invention can also be used for other communications systems, in which different data rates can be realized in a first transmission direction and in a second transmission direction. One system of this kind is the Internet, for which, for example, the modem used can be tested using a method according to the present invention.

In FIG. 1, a connection is established between testing device 1 and a device under test 2, wherein the device under test 2 in the present example is a mobile telephone device. In establishing the connection between the testing device 1 and the device under test 2, all of the parameters required for the operation of a mobile telephone device within a given mobile telephone network are determined by emulating a base station. The connection is therefore established according to the specifications of the respective mobile telephone standard or transmission protocol used.

The connection between the testing device 1 and the device under test is established in a first transmission direction 3 (downlink) and a second transmission direction 4 (uplink), wherein an air interface and also a cable connection can be used for the transmission of information between the testing device 1 and the device under test 2.

To determine the error rate, a known test sequence is transferred, that is to say, a given binary data sequence, to the device under test 2 and then it is determined whether the content of the test sequence known to the testing device 1 has been correctly received and evaluated by the device under test 2. Initially, a test sequence, which includes a given bit sequence, is generated in a sequence generator 5 of the testing device 1 as a first data block. The bit sequences used can differ in an application-specific manner and can therefore be adapted to the respective system under test.

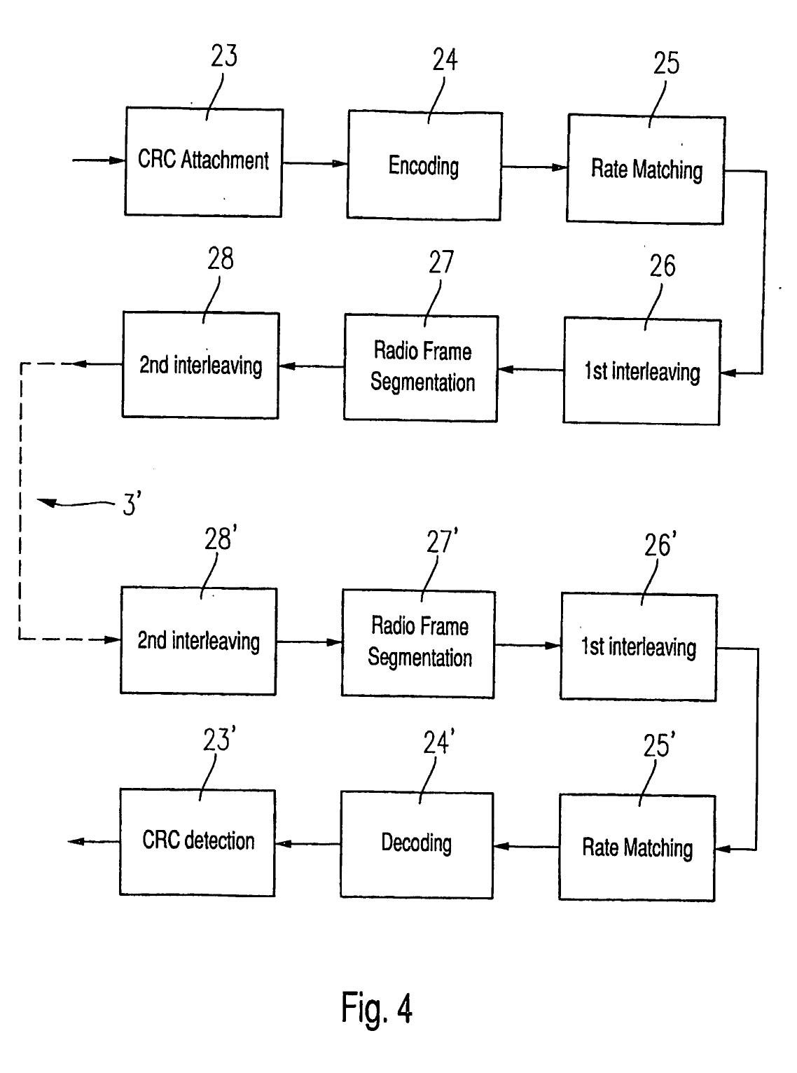

This test sequence is then supplied to a first error-correction element 6, which further processes the test sequence to prevent the occurrence of transmission errors or to allow a correction of errors. The processing of the test sequence in the first error-correction element 6 is explained in greater detail below with reference to FIG. 4.

The test sequence generated in the sequence generator 5 is transmitted in a first transmission direction 3 to the device under test 2 as a test signal. The further processing of the test sequence in the first error-correction element is optional and can also be suppressed. However, if an error correction of this kind is carried out in the first error-correction element 6, the processing of the test sequence in the first error-correction element 6 is reversed by appropriate measures in a second error-correction element 7 of the device under test 2, so that, in the case of an ideal transmission in the first transmission direction 3 or in the case of an optimum error correction, the original test sequence is completely reconstructed at the output of the second error-correction element 7 of the device under test 2.

By contrast, errors may occur at least to some extent during transmission of the test signal or reception and evaluation of the test signal in a real system. This means that, after the evaluation of the test signal at the output of the second error-correction element 7, a bit sequence is present, which differs in content from the test sequence originally generated in the sequence generator 5. This bit sequence of the evaluated test signal is used by the device under test 2 to generate a second data block and from this to generate a response signal.

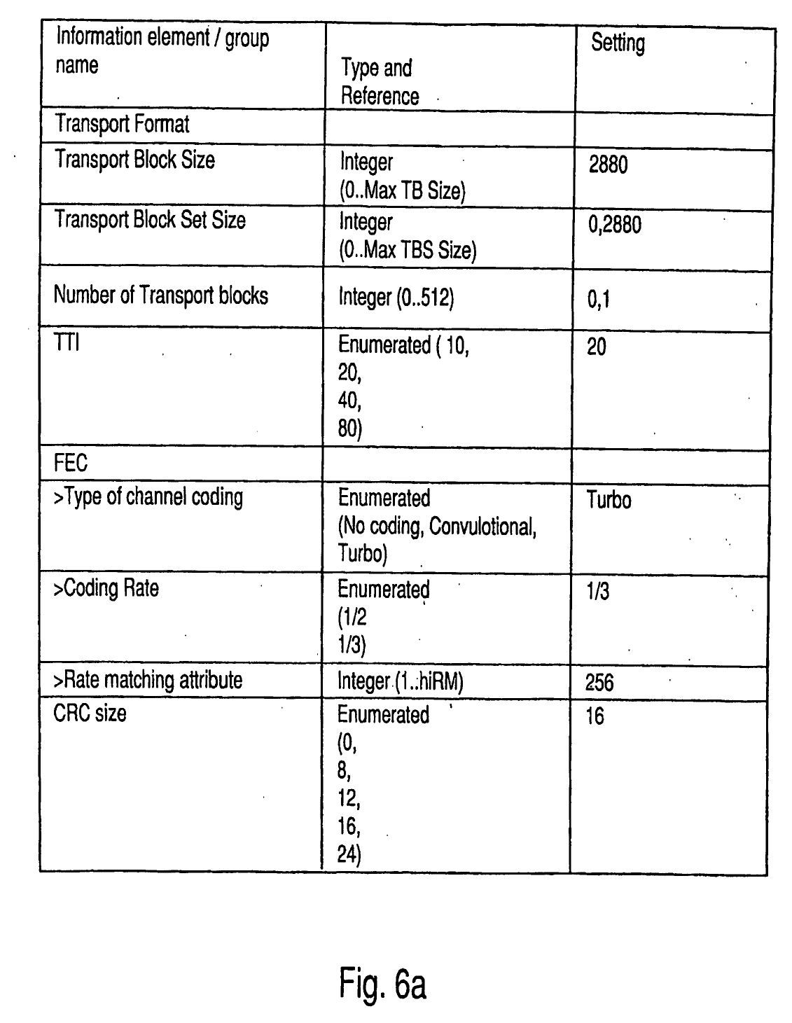

For this purpose, a test section 8 is used (“test loop”), which generates from the evaluated test signal a response sequence, which corresponds to the requirements of the connection, especially in the second transmission direction, established between the testing device 1 and the device under test 2. In an example, in which the length of the data blocks transmitted in the first transmission direction 3 to the device under test 2, is greater than the length of the data blocks transmitted in the second transmission direction 4 from the device under test 2 back to the testing device 1, only those data, for example, beginning with the first bit in the block of the evaluated test signal, which are required in order to generate the second data block of shorter length, are used. This is explained in greater detail below with reference to the description of FIG. 5.

A response sequence, which corresponds, apart from incorrectly recognized bits or unrecognized bits, to a corresponding section of the originally generated test sequence, is generated from the test section 8, as a second data block. Before it is transmitted back to the testing device 1 in the second transmission direction 4 as a response signal, this second data block can be processed for error correction in a third error-correction element 9. A corresponding fourth error-correction element 10, which reverses the measures of the third error-correction element 9 for the correction of any errors occurring in the transmission path in the second transmission direction 4, is provided in the testing device 1.

The received and evaluated response signal is supplied to an evaluation unit 11 of the testing device 1, in which, for example, a bit-error rate (BER) is determined from the evaluated response signal and the test sequence, which is in fact already known to the testing device 1. For this purpose, that section of the test sequence, from which the response sequence of the second data block was generated in the test section 8, is compared bit-wise by the evaluation device 11 with the evaluated response signal. The use of a given section of the test sequence to generate the response sequence of the second data block in the test section 8 in this context is specified by the standard applicable for the relevant system.

As described above, in the example of a mobile telephone device of the third generation presented herein, the respective first coherent data of the test sequence are used to generate the response sequence of the second data block, if the data rate in the first transmission direction 3 is higher than in the second transmission direction 4. To establish the actual quality of the receiver device of the device under test 2 by determining a bit error rate of this kind, the transmission in the second transmission direction 4 must take place with the minimum possible interference, in order to ensure that the evaluated response signal actually matches the response signal of the second data block accurately.

Conversely, a fading simulator 12 can also be used to simulate a real transmission path in the first transmission direction 3 thereby simulating, for example, a weakening of level or time displacements in a real transmission in the downlink and determining their influence on the accurate evaluation of the test signal by the receiver device of the device under test 2.

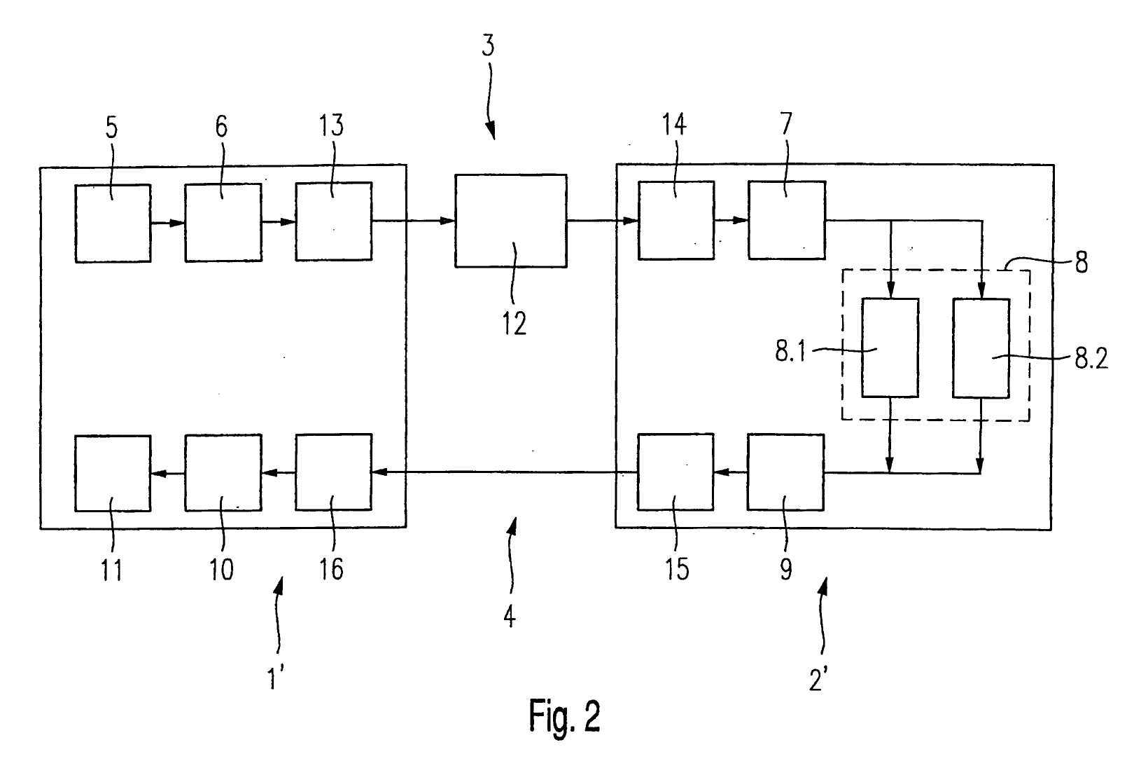

FIG. 2 shows a detailed view of a testing device 1′ and a device under test 2′. The components of the testing device 1 and the device under test 2 for the implementation of the method according to the invention discussed with reference to FIG. 1 are marked with identical reference numbers in FIG. 2. To avoid unnecessary repetition, further description of these components is not provided.

The testing device 1′ illustrated in FIG. 2 comprises, in addition to the sequence generator 5 and the first error-correction element 6, a modulator 13, through which the test sequence, which may be processed by means of the error-correction element 6, is further processed to form a high frequency signal. This further processing includes, amongst other factors, the mixing of a baseband signal to a carrier frequency, with which the test signal then present is transmitted in the first transmission direction 3.

Accordingly, a demodulator 14 is provided in the device under test 2′, in order to recover from the test signal transmitted in the first transmission direction 3 the original information of the test sequence generated in the sequence generator 5. After subsequent error correction in the second error-correction element 7, the test signal evaluated in this manner is supplied to the test section 8. In the exemplary embodiment shown in FIG. 2, two alternative embodiments are shown for the test section 8. The test section 8 comprises a first variant 8.1 and a second variant 8.2. The first variant 8.1 and the second variant 8.2 represent different layers of an OSI reference model, on which the so-called “test loop”, in which the response sequence is generated from the evaluated test signal, can be arranged.

For a given transmission protocol, these possibilities are specified in the relevant standard. Given the example of a UMTS system, “layer 1” or the “RLC (Radio Link Control) layer” is specified by the standard. According to the specifications of the standard, a choice is possible between the two different variants 8.1 and 8.2 of the test section 8. This choice is determined by the respective testing device 1′ connected to the device under test 2′ preferably during the establishment of the connection. The evaluated test signal is supplied according to the specifications either to “layer 1” for the first variant 8.1 or to the “RLC layer” for the second variant 8.2, so that a response signal is generated from the evaluated test signal by one of these variants 8.1 or 8.2 respectively.

This response sequence passes through the third error-correction element 9. The function of the error-correction element 9 can also be switched to transparent mode, that is to say, an error correction is not carried out with the supplied data of the response sequence. This so-called “transparent mode” is also possible for the other error-correction elements, and is also preferably determined during the establishment of the connection by the testing device 1′ or respectively the testing device 1 from FIG. 1.

The response sequence is once again further processed by a modulator 15 of the device under test 2′ to form a transmissible response signal, so that a response signal is finally transmitted back by the device under test 2′ in the second transmission direction 4 to the testing device 1′. The receiver of the testing device 1′ is fitted with a corresponding demodulator 16, so that the received response signal can be received and evaluated. If an error correction has been implemented by the device under test 2′, then the demodulated response signal is supplied to the fourth error-correction element 10 before the completely evaluated response signal is finally compared bit-wise in the evaluation unit 11 with the originally generated test sequence. By comparing the originally-generated test sequence with the completely-evaluated response signal, a bit-error rate or a block-error rate, for example, can then be determined by the evaluation unit 11. In determining a block-error rate, every block, which contains at least one bit error, is evaluated as a block error.

When using the method according to the invention, for example, for a UMTS system, the data rate in the first transmission direction 3 and in the second transmission direction 4 is determined by the testing device 1′. Especially during the establishment of the connection, the testing device 1′ determines the position within the device under test 2′, at which the “test loop” is to be placed, that is to say, whether the first variant 8.1 or the second variant 8.2 of the test section 8 is to be used. The testing device 1′ does not participate in the actual implementation of the evaluation of the test signal after the transmission in the first transmission direction 3 or in the subsequent generation of a response sequence for the second data block, but the device under test 2′ executes a routine, which is defined in the relevant standard.

To evaluate the response signal or to determine an error rate resulting from it, the testing device 1′ determines the section of the test sequence, to which the evaluated response signal should, under ideal circumstances, be identical. Dependent upon the length of the data blocks used for the transmission in the first transmission direction 3 and the second transmission direction 4, the testing device 1′ therefore compares the full length of the evaluated response signal with a corresponding section of the test sequence if the length of the first data block is greater than that of the second data block.

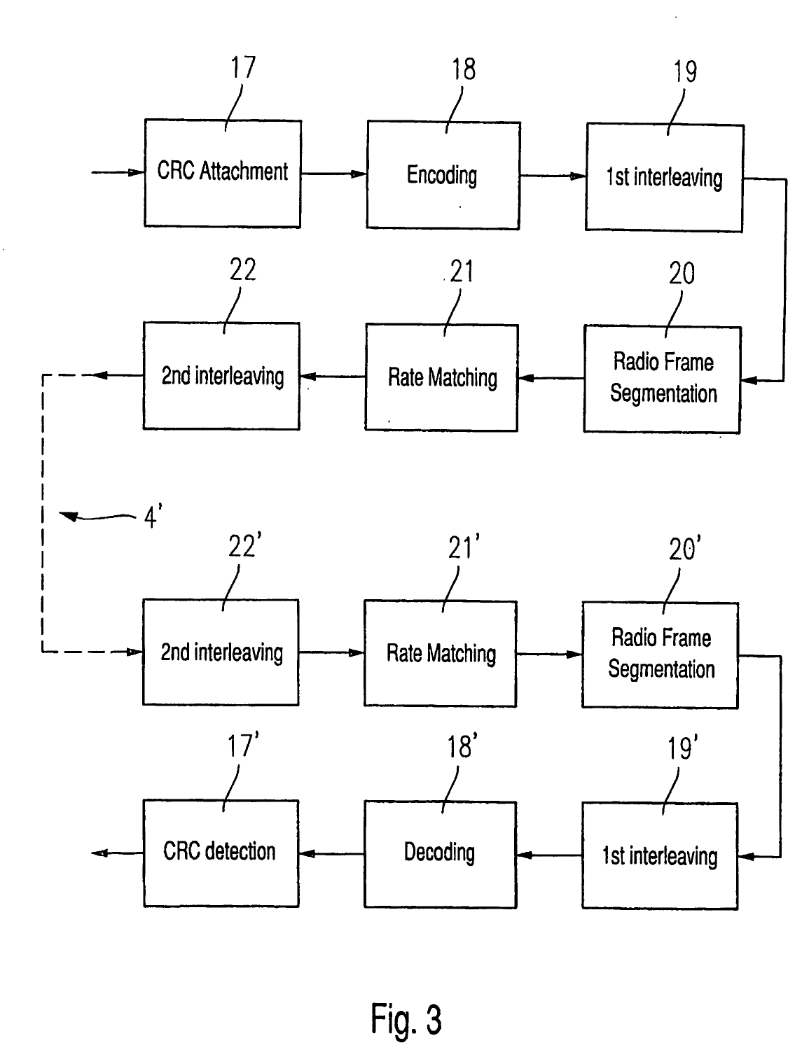

FIG. 3 shows in a very much simplified form the individual stages during the processing of the data sequence used for the generation of the response signal by the third error-correction element 9 or respectively, in the testing device 1 or 1′, in the fourth error-correction element 10. In a first stage 17, a checksum, for example, a CRC (Cyclic Redundancy Check) sum is added to the response sequence. The response sequence generated in this manner, to which the checksum has been added, is encoded in a next stage 18, for example, by “convolutional coding” or “turbo coding”, the various viable coding algorithms being established by the relevant transmission standard.

In a third stage 19, the encoded data sequence is interleaved for a first-time, that is to say, the sequence of information contained in the encoded data sequence is exchanged according to a predetermined scheme. Following this, in stage 20, individual data packets are formed, the individual data packets being formed according to the specifications, for example, of frame structures, which follow a given time system. In the case of a UMTS system, the data rate is matched, in the subsequent stage 21, to the physical channel by bit repetition or bit blanking. The physical channel is established in the second transmission direction 4 dependent upon the data rate to be transmitted. The sequence present after this stage is interleaved once again in a further stage 22, before the sequence is subjected to spreading using orthogonal spreading codes.

After spreading, the data to be transmitted are provided as a chip sequence.

The data present in this form are then transmitted in the manner already described in the second transmission direction 4′, wherein the second transmission direction 4′ indicated in FIG. 3 by a dotted line, symbolizes that a further processing takes place after the second interleaving in stage 22. The error-correction processes carried out in stages 17 to 22 with the response sequence are cancelled again in a stepwise manner by the fourth error-correction element 10 in the testing device 1 or 1′ in the corresponding processing stages 22′ to 17′, which are not described here because they proceed in a similar manner to the processing stages 17 to 22, but in reverse order.

FIG. 4 shows a second possible procedure for error correction in the first error-correction element 6 of the testing device 1 or 1′ and the second error-correction element 7 of the device under test 2 or 2′. The stages 23 and 24 correspond to the stages 17 and 18 as discussed previously with reference to FIG. 3. However, in the subsequent stage 25, the data rate is matched to the physical channel by bit repetition or bit blanking. The sequence provided after this stage is interleaved in stage 26. In stage 27, the bit block is segmented into the corresponding frame structure, which is specified in the relevant transmission standard. The information now segmented into individual bit packets of the frame is interleaved once again in stage 28.

In procedural stages 28′ to 23′, the error-correction element 7 provided in the device under test 2 or 2′, once again in a similar manner, reverses the stages 23 to 28 implemented for error correction in the first error-correction element 6.

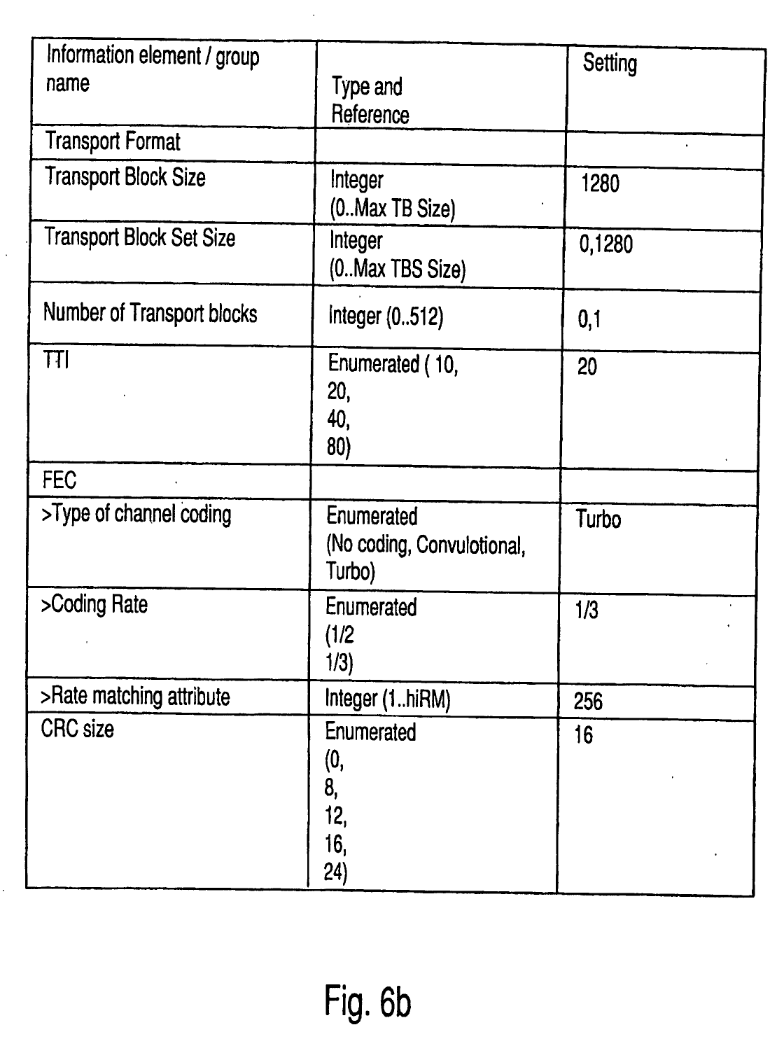

FIG. 5 again illustrates how a second data block, which will be used in the evaluation unit 11 of the testing device 1′ for comparison and therefore for determination of the error rate, is generated by the device under test 2′, for example, from a first data block. For a signal of the downlink, that is to say, in the first transmission direction 3 of the mobile telephone system described by way of example, a length, for example, of 2880 bits, is determined for the first data block. A transmission time (TTI, Transport Time Interval), within which this data volume will be transmitted, is additionally determined. The data determined are presented in the table in FIG. 6a.

Accordingly, the first data block provides a total length of 2880 bits, which can be subdivided into a first section 29.1 and a second section 29.2. The length of the entire first data block 29 is identical to the length of the test sequence generated in the sequence generator 5. This test sequence is processed in the manner described above, wherein, amongst other factors, a checksum 30 is added, before the test signal is transmitted in the first transmission direction 3 to the device under test.

If the error correction in the second error-correction element 7 has not been switched to transparent mode, the processing of the received test signal takes the checksum 30 into consideration. In this context, some of the original data of the test sequence are corrected by the second correction element 7 of the device under test 2 or 2′, if the relevant, missing information can be corrected, for example, with redundant information.

The data obtained in the evaluation of the test signal from the first section 29.1 correspond to the data used as the response sequence for the response signal and therefore form the second data block 31. The response sequence is formed by the device under test 2 or 2′, in that those data, which are determined in the evaluation by the device under test 2 or 2′ as a content of the first section 29.1, form the response sequence. In the evaluation, the content of the second section 29.2 is taken into account in that the entire information of the first data block and the checksum 30 is used for error correction.

The length of the second data block 31, for example, corresponding to the data rate determined by the testing device 1 or 1′, is 1280 bits, which must also be transmitted within a transmission time, for example, of 20 ms. Accordingly, only the content determined from the test signal of the first section 29.1 is used as data for the second transmission block, so that the data u′₀ to U′ₖ₋₁ of the entire second data block 31 are generated from the evaluated data u₀ to uₖ₋₁ of the original test sequence. The parameters for the second transmission direction 4 are shown in FIG. 6b.

A second checksum 32, which contains the redundant information to the response sequence, is added to these data of the second data block 31, before the second data block 31 together with the second checksum 32 is transmitted back to the testing device 1 or 1′ in the second transmission direction 4. This response signal is then evaluated, wherein it is ensured by an appropriate test environment, that, at least approximately, no transmission errors occur in the second transmission direction 4. In the evaluation unit 11 of the testing device 1 or 1′, the content of the evaluated response signal is then compared bit-wise with the content of the first section 29.1 of the first data block 29.

To generate a response sequence from a test signal, of which the underlying first data block is shorter than the second data block corresponding to the response sequence, for example, filling data can be used, or a given, predetermined bit sequence can be used.

For every deviation of the data, a bit error is then counted, from which the bit error rate is determined relative to the total number of bits transmitted. To determine the block error rate, each block, in which a bit error occurs, is at the same time counted as a block error.

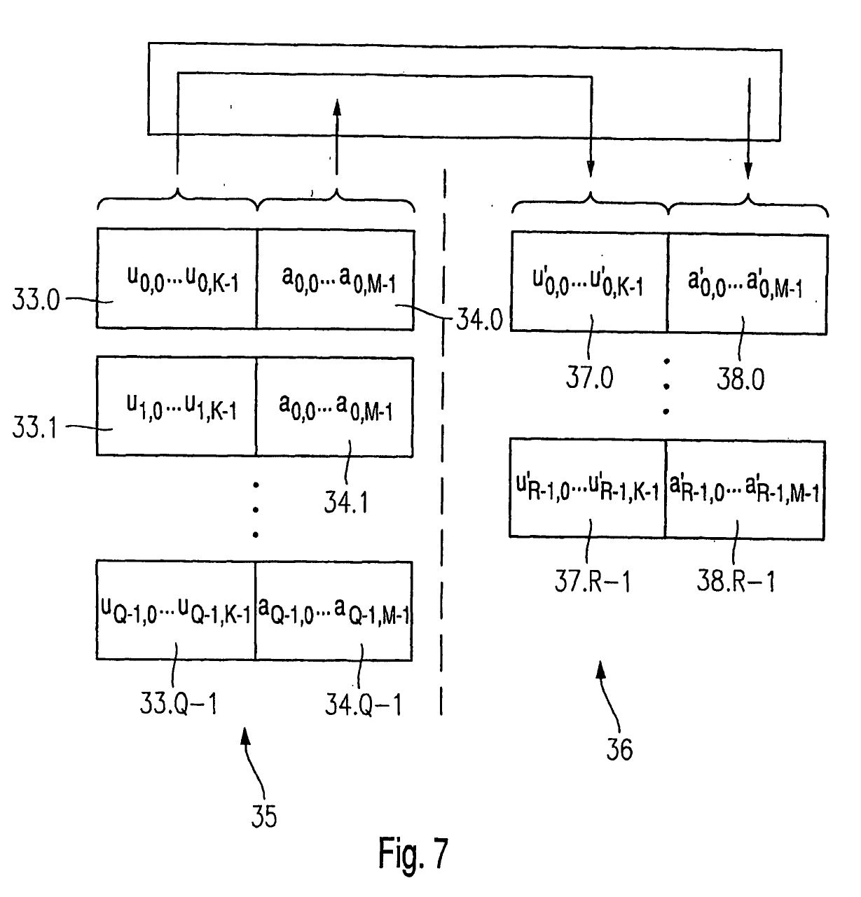

As explained above, it is of decisive importance for the statistical value of the measured result that different data rates are used for the two transmission directions in a bidirectional channel. In addition to the use of data blocks of a different length, which has been explained in detail with reference to FIG. 5, it is also possible to form the test signal from a first group 35 with several data blocks 33.0 to 33.Q-1. This is shown in FIG. 7. The respective data rate is then determined by the number of data blocks transmitted per unit of time.

In the exemplary embodiment illustrated, a first number Q of data blocks 33.0 to 33.Q-1 are used to form a first group 35. These data blocks 33.0 to 33.Q-1 are all of the same length. An individual checksum 34.0 to 34.Q-1 is added to each data block 33.0 to 33.Q-1 to allow an error correction.

A test signal, which is evaluated in the device under test 2, 2′, is formed from this group 35 of data blocks 33.0 to 33.Q-1. A second group 36 with a second number R of data blocks 37.0 to 37.R-1 is formed on the basis of the evaluated test signal. A checksum 38.0 to 38.R-1 is also added to each of the individual data blocks 37.0 to 37.R-1 of the second group.

In particular, the data blocks 37.0 to 37.R-1 of the second group 36 are of the same length as the data blocks 33.0 to 33.Q-1 of the first group 35. To determine an error rate, the corresponding data blocks 33.0 to 33.Q-1 and 37.0 to 37.R-1 of the first and second group 35 and 36 respectively are compared with one another bit-wise in the testing device 1 or 1′.

In order to realize different data rates in the two transmission directions 3 and 4, the first number Q of data blocks 33.0 to 33.Q-1 of the first group 35 and the second number R of data blocks 37.0 to 37.R-1 of the second group 36 differ from one another.

In the case of an error-free transmission of all data blocks, the data blocks of the group 35 or 36, which has the lower number Q or R of data blocks 33.0 to 33.Q-1 or 37.0 to 37.R-1 respectively, preferably agree with the first data blocks of the other group 36 or 35 respectively. However, the data blocks 37.0 to 37.1-R can also be formed in such a manner that, for example, an agreement with every second one of the data blocks 33.0. to 33.Q-1 is provided in an error-free transmission.

In addition to the number of data blocks 33.0 to 33.Q-1 and 37.0 to 37.R-1 in the groups 35 and 36, the length of the data blocks 33.0 to 33.Q-1 of the first group 35 can also differ from the length of the data blocks 37.0 to 37.R-1 of the second group 36. However, the length of the data blocks 33.0 to 33.Q-1 or 37.0 to 37.R-1 within one group 35 or 36 respectively is preferably identical in each case.

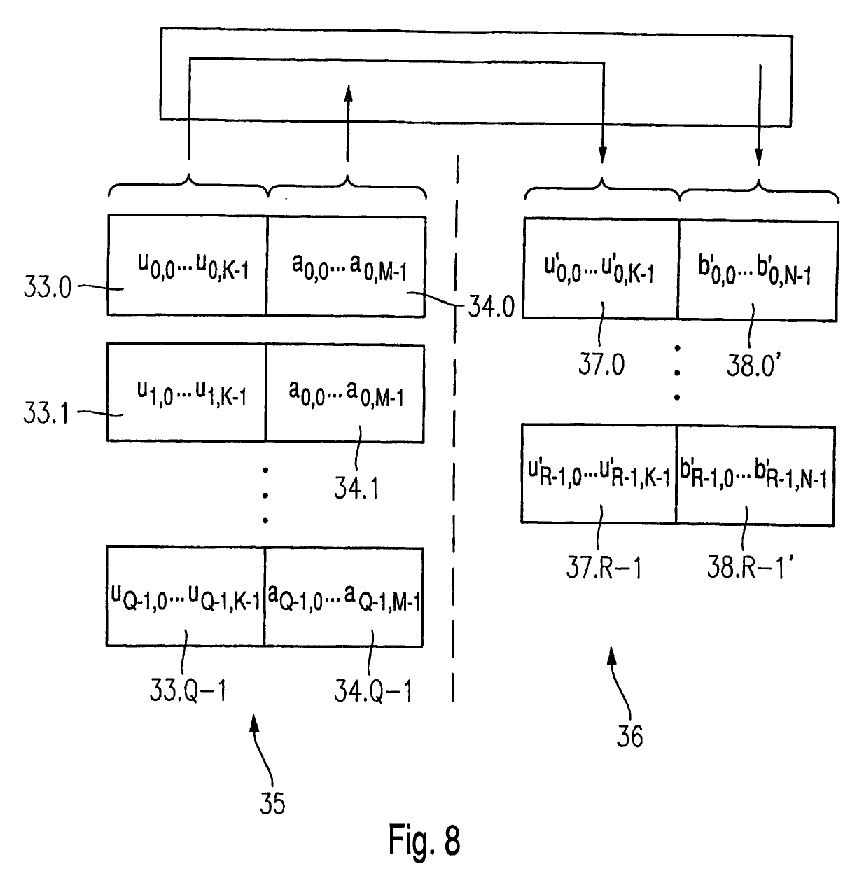

By way of difference from the checksums 38.0 to 38.R-1 of the data blocks 37.0 to 37.R-1 of the second group 36, which agree with the format of the checksums 34.0 to 34.Q-1 of data blocks 33.0 to 33.Q-1 of the first group 35, as illustrated in FIG. 7, FIG. 8 shows an exemplary embodiment, in which, checksums 38.0′ to 38.R-1′, which differ in format from the checksums 34.0 to 34.Q-1 of the data blocks 33.0 to 33.Q-1 of the first group 35, are used for the data blocks 37.0 to 37.R-1 of the second group 36.

To avoid repetition, further description of the agreeing elements of the exemplary embodiment shown in FIGS. 7 and 8 is not provided herein.

The exemplary embodiments are shown for the case that the first number Q of data blocks 33.0 to 33.Q-1 of the first group 35 is greater than the second number R of data blocks 37.0 to 37.R-1 of the second group 36. This corresponds to the assumption of a greater data rate in the first transmission direction 3. As with the use of different lengths for the data blocks in order to realize different data rates, the data rate in the second transmission direction 4 can also be greater. In the corresponding case, the second number R is greater than the first number Q.

The additional number of data blocks 37.0 to 37.R-1 is then filled with a predetermined data content by the device under test 2, 2′.

The invention is not limited to the exemplary embodiments illustrated, but also covers the combination of individual features from different exemplary embodiments.

While the present invention has been described in connection with a number of embodiments and implementations, the present invention is not so limited but covers various obvious modifications and equivalent arrangements, which fall within the purview of the appended claims.

1. A method for determining an error rate in a bidirectional data transmission between a testing device and a device under test, comprising the steps of:
generating a first data block of having a first length by a the testing device,
transmitting, by the testing device, a test signal generated based on the first data block with a first data rate;
receiving and evaluating the test signal by the device under test;
generating, based on the evaluated test signal, a second data block having a second length, different from the first length;
returning transmission, by the device under test, of a response signal generated based on the second data block with a second data rate, different from the first data rate;
receiving and evaluating the response signal by the testing device; and
determining an error rate based on a comparison of content of the evaluated response signal with a corresponding section of the first data block if the first data block is longer than the second data block or based on a comparison of content of the first data block with a corresponding section of the evaluated response signal if the second data block is longer than the first data block.

2. A method according to claim 1, wherein
if the first length is greater than the second length, the second data block includes content of a section of the evaluated test signal.

3. A method according to claim 1, wherein
if the second length is greater than the first length, the second data block, includes filling data and content of the first data block.

4. A method according to claim 1, wherein
a transmitter/receiver of the testing device determines a plane of an OSI-reference model in the device under test on which the second data block is generated based on the evaluated test signal.

5. A method according to claim 1, wherein
the first length and the second length are determined by the testing device for a transmission direction of the transmitting by the testing device and for a transmission direction of the returning transmission during establishment of a connection between the testing device and the device under test.

6. A method for determining an error rate in a bidirectional data transmission between a testing device and a device under test, comprising the steps of:
generating, by the testing device, a first group including a first number of data blocks;
transmitting, by the testing devices, of a test signal generated based on the first group with a first data rate;
receiving and evaluating the test signal by the device under test;
generating a second group including a second number of data blocks based on the evaluated test signal, wherein the second number differs from the first number;
returning transmission, by the device under test, of a response signal generated based on the second group of data blocks with a second data rate different from the first data rate;
receiving and evaluating the response signal by the testing device; and
determining an error rate based on a comparison of content of the evaluated response signal with corresponding data blocks of the first group, if the first number is greater than a the second number, or based on a comparison of content of the first group of data blocks with corresponding data blocks of the second group of the evaluated response signal if the second number is greater than the first number.

7. A method according to claim 6, wherein
if the first number is larger than the second number, the data blocks of the second group include content of the first data blocks of the first group of the evaluated test signal.

8. A method according to claim 6, wherein
if the second number is greater than the first number, the data blocks of the second group include filling and content of the evaluated first group of data blocks.

9. A method according to claim 6, wherein
a transmitter/receiver determines a level of an OSI reference model in the device under test, on which the second group of data blocks is generated based on the evaluated test signal.

10. A method according to claim 6, wherein
the first and the second number of data blocks of the first and the second group for a transmission direction of the transmitting by the testing device and for a transmission direction of the returning transmission are determined by the testing device during the establishment of a connection between the testing device and the device under test.

11. A method according to claim 6, wherein
the first number or the second number of data blocks is a maximum in at least one transmission direction.

12. A method according to any claim 1, wherein
data blocks of a maximum length are used in at least one transmission direction.

13. A method according to claim 1, wherein
the test signal and the response signal are baseband signals.

14. A testing device for determining an error rate for a receiver device of data transmitted in a first transmission direction to a device under test comprising a sequence generator for the generation of a first data block with a first length and a transmitter/receiver for the transmission of a test signal generated based on the first data block and for the reception and evaluation of a response signal transmitted by the device under test based on second data block having a second, length different from the first length, and an evaluation device for the determination of an error rate of contents of the first and second data blocks, wherein the content of the respective shorter data block of the first and second data blocks is compared, by the evaluation device, with a corresponding section of the longer data block of the first and second data blocks, to determine the error rate.

15. A testing device according to claim 14, wherein the testing device determines a level of an OSI reference model of the device under test on which the second data block is generated from the evaluated test signal.

16. A testing device according to claim 14, wherein
the first and second lengths of the respective data blocks for the first transmission direction and the second transmission direction are determined by the testing device during establishment of a connection between the receiver and the device under test.

17. A testing device for determining an error rate for a receiver of data transmitted in a first transmission direction to a device under test comprising a sequence generator for the generation of a first group having a first number of data blocks and a first transmitter/receiver for the transmission of a test signal generated based on the first group of data blocks and for the reception and evaluation of a response signal transmitted in a second transmission direction from the device under test based on a second group having a second number of data blocks, wherein the second number differs from the first number, and an evaluation device for the determination of an error rate of the contents of the first and second groups of data blocks, wherein content of the data blocks of the first or second group having a respective smaller number of the first and second number of data blocks is compared, by the evaluation device for determining the error rate, with the corresponding data blocks of the second or the first group having a larger number of the first and second number of data blocks.

18. A testing device according to claim 17, wherein
the testing device determines a level of an OSI reference model of the device under test on which the second group of data blocks is generated based on the evaluated test signal.

19. A testing device according to claim 17, wherein
the first and second numbers are determined by the testing device during establishment of a connection between the receiver and the device under test.

20. A testing device according to claim 17, wherein
the first number or the second number of data blocks is a maximum in at least one transmission direction.

21. A testing device according to claim 14, wherein
data blocks of a maximum length are used for at least one transmission direction.

22. A testing device according to claim 14, wherein
the test signal and the response signal are baseband signals.
